(19) United States
(12) Patent Application Publication
(10) Pub. No.: US 2008/0010211 A1
(43) Pub. Date: Jan. 10, 2008

(54) Backup, refund and restore of postal device funds

(76) Inventor: Mark Ferraro, Hamden, CT (US)

Correspondence Address: KENYON & KENYON LLP, 1500 K STREET N.W., SUITE 700, WASHINGTON, DC, 20005, US

(21) Appl. No.: 11/898,042

(22) Filed: Sep. 7, 2007

Related U.S. Application Data
(63) Continuation-in-part of application No. 11/343,318, filed on Jan. 31, 2006.

(51) Int. Cl. G06Q 50/00; G06F 17/00

(52) U.S. Cl. 705/60; 705/405

(57) ABSTRACT

Systems, apparatuses and methods for restoring data related to funds for franking mail on a postal device in response to a hardware failure. A postal device may include a memory for storing funds data. For example, an ascending register may store the amount of funds charged by franking mail or a descending register may store the amount of funds remaining to frank mail. Once one or more pieces of mail have been franked, the funds data may be transferred to, and stored in, a storage base in a secure fashion. In response to a hardware failure of the postal device, the secure funds data may be retrieved from the storage. A replacement postal device may then be restored or reset based on the secure funds data received from the storage base. Alternatively, a customer account can be refunded based on the secure funds.

### CROSS REFERENCE TO RELATED APPLICATIONS

This application is a continuation-in-part of U.S. patent application Ser. No. 11/343,318 filed Jan. 31, 2006, the entirety of which is incorporated by reference herein.

### BACKGROUND OF THE INVENTION

1. Field of the Invention

The present invention generally relates to franking machines (e.g., postage meters) and systems that include franking machines. More specifically, the present invention provides for the backup and restore of data on postage meters, including the refund of postal device funds.

2. Background Art

A postal device may be used in a system for franking (or printing indicia on) mail pieces. An internal data memory, perhaps in the form of a register or registers, may store values related to the funds used to frank the mail pieces. For example, a descending register may store a value of the funds available for franking. Funds may then be deducted from that stored value each time a mail piece is processed. In another example, the internal data may store funds related to mail already franked. For example, an ascending register may track a running total of funds charged for franking each piece of mail individually.

The postal device is typically a secure device designed to prevent or deter tampering since the postal device stores information related to pre-allocated and unused funds. A postal device may include, but may not be limited to, a processor for carrying out instructions related to franking mail and tracking the funds related to the franked mail, an internal memory for storing the funds data, and a communications module for interfacing with other elements of the postage meter system. A postage printing base (PPB) may be in communication with the postal device and may affect the printing of indicia on mail pieces.

Funds data is often stored in memory within the postal device. Because the postal device can fail (e.g., internal memory can fail, the postal device can become damaged, or a software failure can cause the device to become inoperable or otherwise unusable) the funds data may be lost. Other hardware failures may also cause the postal device to become inoperable such that, in turn, funds data stored in the postal device becomes inaccessible or otherwise unusable or unrecoverable. Subsequently replacing the funds on a postal device may be impossible or difficult at best because the individual users of the postal device must appeal to the postal authority to obtain a refund. This procedure often requires proving the state of the funds prior to the hardware or memory failure (e.g., the exact value of the descending register), a procedure which is difficult without a reliable record of the funds data. Alternatively, the funds data may be recovered by “cutting into” the failed postal device. This task requires specialized technicians and equipment and can require a substantial investment of time.

It is therefore an object of the present invention to provide systems and methods for reliably restoring funds on a postal device in a more efficient and low cost manner. It is also an object of the present invention to provide systems and methods for reliably refunding unused funds of a postal device.

### BRIEF DESCRIPTION OF THE DRAWINGS

The accompanying drawings illustrate the present invention and, together with the description, further serve to explain the principles of the invention and to enable one skilled in the pertinent art to make and use the invention.

FIG. 1 is an embodiment of a method in accordance with the present invention.

FIG. 2 is an embodiment of a system in accordance with the present invention.

### DETAILED DESCRIPTION OF THE INVENTION

Embodiments of the present invention provide systems, apparatuses and methods for restoring data related to funds for franking mail using a postal device in response to a hardware failure (e.g., a memory failure). Embodiments of the present invention also provide systems, apparatuses and methods for refunding unused funds of a postal meter that becomes inoperable.

A postal device may include a memory for storing funds data. For example, an ascending register may store the amount of funds charged by franking mail or a descending register may store the amount of funds remaining to frank mail. A piece count register can also store the number of mail pieces processed or franked by the postal device. Once one or more pieces of mail have been franked, the funds data may be transferred to and stored in a storage base. In response to a hardware failure of the postal device, the funds data may be retrieved from the storage base by the postal device or a replacement postal device. The postal device or replacement postal device may then restore the funds data based on the funds data received from the storage base. Restoration may or may not include funds related to mail franked since the last transfer. Further, if restoration of the failed postal device (or resetting of a new replacement device) is not possible, unused funds of the failed postal device can be refunded to an owner or user of the failed postal device.

Funds from a postal meter can also be restored to a postal device or refunded to an operator, owner or vendor (e.g., the party that provides the funds for use with the postal meter) of a postal device using information provided in mailpiece indicia that is scanned and processed by a postal authority or carrier. Mailpiece indicia can include information (e.g., securely coded data) such as an identifier of the postal meter which produced the indicia as well as the accounting register state of the postal meter at the time of creation of the indicia (e.g., an ascending, descending and/or piece counter register value). When a postal meter becomes inoperable, the scanned indicia stored and retained by the postal authority can be used to accurately determine the funds state of the postal meter at the time of failure.

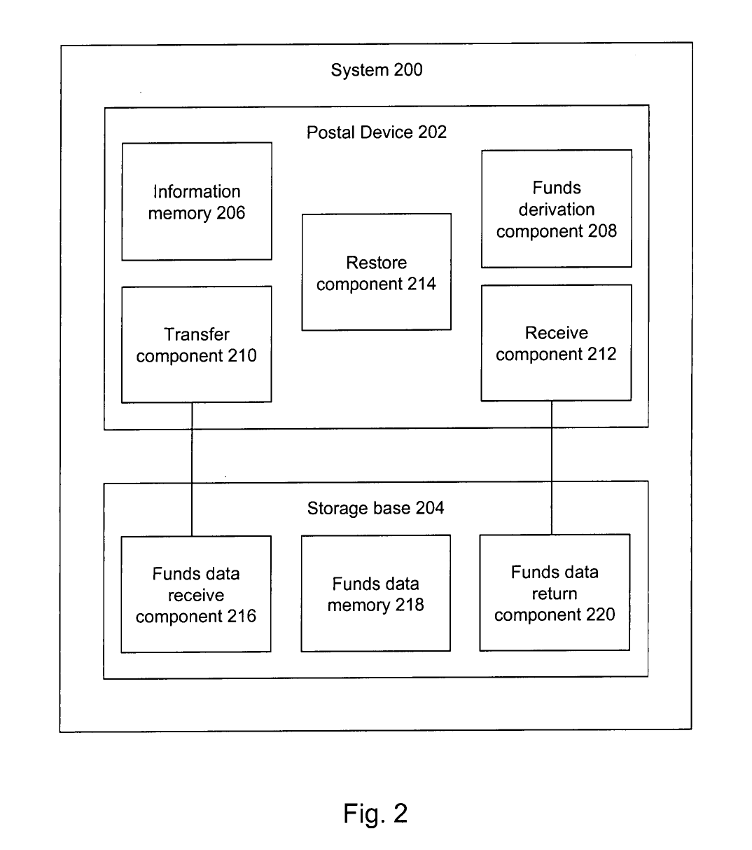

FIG. 2 is an embodiment of a system in accordance with the present invention. The system 200 may include a postal device 202 and storage base 204. It is contemplated that various configurations of multiple postal devices and storage bases may exist. For example, a single postal device may be coupled to multiple storage bases. In this way, the funds data may be further secured against hardware failures, occurring at one or more storage bases. Other configurations may include a single storage base serving multiple postal devices concurrently.

The postal device may include an information memory 206 and a funds derivation component 208. The funds derivation component 208 may derive the funds data from the funds information in the information memory 206. A transfer component 210 may be operably connected to a funds data receive component 216 of the storage base 204. As described below, this communications link may include various network topologies and direct connections.

The storage base 204 may also include a funds data memory 218 for storing the funds data and a funds data return component 220. The funds data return component 220 may be operably connected to a receive component 212 of the postal device 202. This communications link may include various communications topologies. In some example embodiments, the communications links between the transfer component 210 and the funds data receive component 216, and between the funds data return component 220 and the receive component 212, may be the same bidirectional communications link. Overall, the type of function of the one or more communication links between the postal device 202 and storage base 204 are immaterial to the present invention unless otherwise indicated herein.

A restore component 214 may calculate the data to be stored in the information memory 206 from the funds data, if necessary, and store the data in the information memory 206. The restore component 214 may also perform any additional calculations based on mail franked since the last transfer of the funds data to the storage base 204. In this way, the funds information in the information memory 206 may be restored to its state prior to a hardware failure. The funds information can be restored to the original failed postal device or to a new replacement postal device.

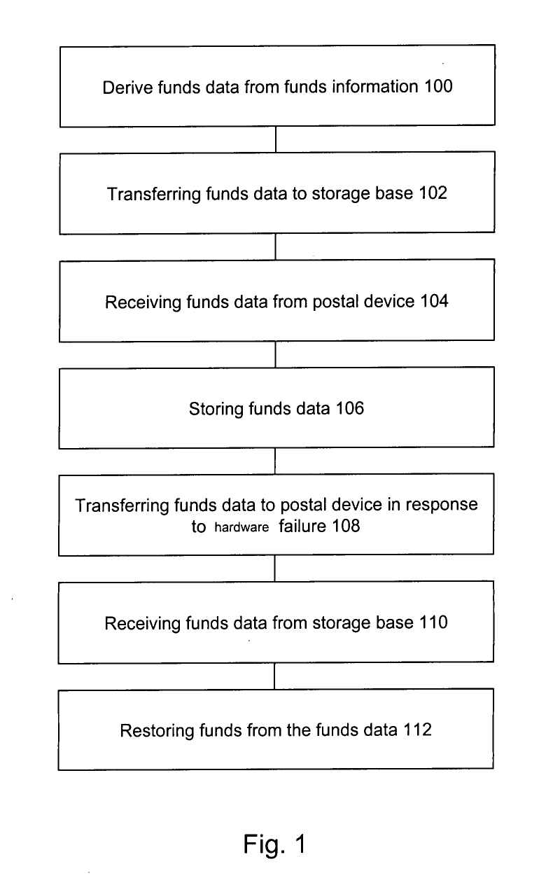

FIG. 1 is an embodiment of a method for restoring postal funds in accordance with the present invention. The method for restoring postal funds can be implemented using, for example, the system depicted in FIG. 1. An information memory of a postal device may store funds related to franking mail. A postal device may include components necessary to frank mail. For example, franking mail may include applying postage to the mail. Facilities of a postal device for accomplishing this task may include, for example, input components, output components, processing components, memory components, communications components, etc. Input components may include, for example, key entry components, such as keyboards, keypads, buttons, sliders, jog dials, track pads, mouse components, voice input components, etc. Other input components may include, for example, microphones, touch screens, accelerometers, bar code scanners, etc.

Output components may include, for example, visual output components, such as screens and LEDs, audio output components, vibrating components, olfactory components, printing components, etc. For example, one output component may be used to print indicia on franked mail. Processors may include any processor capable of executing software specific to franking mail or general software, such as a web browser, that interfaces with software on another component or server. Memory components may include volatile memory as well as memory that may be preserved if the postal device is powered off. Memory may preferably be writable memory. Writable memory may be important if the tasks of franking mail require data to be updated or stored during the tasks themselves. Communications components may include wired communication components, such as IP-based network components, and wireless communication components, such as wireless networking, cellular telephone, satellite communication components, etc.

Other example embodiments may include other functionalities for the foregoing components than the embodiments described, as well as additional functionalities apart from franking mail itself. For example, an example postal device may include a cellular telephone capable of sending and receiving telephone calls, in addition to serving as a postal device for franking mail. In another example embodiment, the postal device may include a desktop personal computer. In other example embodiments, the postal device may include functionality such as a global positioning system locator, bar code scanner, word processing applications, etc. In another example embodiment, the postal device may include both electronic and physical security components to ensure that the data within the postal device is free from tampering. One example of such a postal device may be the postal security device of U.S. Pat. No. 7,171,392.

An information memory of the postal device may store information related to funds for franking mail. The information may be varied in accordance with the requirements of the postal system. For example, the information may include funds data related to franking mail. For example, the funds information may include values of an ascending register that stores a running total of funds charged for franking mail (i.e., a value of an ascending register). The funds information may also include a descending register value. The funds information may also include a postal device identifier (e.g., a unique code identifying the specific postal device). Further, the funds information may store a running total of the number of pieces of mail franked (i.e., a value of a piece count register). For example, the mail franked may belong to a batch of mail, where all mail pieces have the same amount of postage applied to them.

In yet another example embodiment, the running total may include running totals for mail franked for various categories of mail. For example, various categories of mail may each be associated with an amount of postage for that category. Calculating a funds data may involve multiplying the funds associated with a particular category with the number of mail items franked in that category. In some example embodiments, the information may include data such as a history of mail franked, including names and addresses of the sender and recipients. Other example embodiments may include data related to times and dates of when the mail was franked, as well as the weight and size of the mail franked, such as for auditing purposes.

Any and all of this information can be stored on the indicia of a mailpiece processed by a postal device. The information can then be made available after scanning of the indicia by a postal authority and storage of the indicia's information in a database accessible by an owner/operator of the postal device.

The funds data may be derived from the funds information (block 100). As discussed, the funds data may correspond to the funds information or may be calculated based, at least in part, on the funds information. For example, the funds information may include the amount of funds for franking mail and may be the same as the funds data. However, the funds information may store information different than the funds for franking mail. As in the above example, the funds information may include the number of pieces of mail franked. The funds data may be calculated by multiplying the number of pieces of mail by the cost for each piece of mail. This example embodiment is particularly useful where the mail items each include the same cost for franking the mail. In another example embodiment, discounts may be applied to the funds information in deriving the funds data. For example, if a discount of ten percent is to be applied for franking more than one hundred dollars of mail, then a ten percent discount may be applied to any funds information in excess of $100.

In other example embodiments, a surcharge may be applied to the funds information. For example, if the balance of funds has not been paid for a period of time, a surcharge may be applied in calculating the funds data. In another example embodiment, a surcharge may be applied if the stored value of funds in the postal device goes below a certain amount. Such a scheme may encourage mailing departments to keep their funds balance sufficiently high so as not to be at risk of running out of funds.

The funds data may be transferred to a storage base (block 102). A storage base may exist to store the funds data. The storage base may be located locally, for example, perhaps physically attached to the postal device, or, for example, may exist in a separate location. In example embodiments where the postal device and storage base are physically attached, circuitry may connect the postal device to the storage base. For example, the storage base may include removable storage, such as a flash memory device or removable, rewriteable storage device. In another example embodiment, the storage base may include a memory chip that exists within the postal device which is connected to the circuitry of the postal device.

In example embodiments where the postal device and storage base are physically detached, the postal device and storage base may be operably connected over a communications link, such as a direct connection, wired or wireless network, or the like. For example, a direct connection may include a wired or wireless link over which the postal device may send and receive information from the storage base, such as serial RS232, universal serial bus, IEEE 1394, etc. Network connections, for example, may include wired networks, such as local area networks, wide area networks, IP-based networks, ATM, frame relay networks, etc., or Ethernet, or wireless networks, such as broadcast networks, point to point wireless networks, WIFI networks, etc., or combinations of any of the foregoing.

Communications from the postal device to and from the storage base may be carried out using various protocols. For example, protocols with guaranteed delivery, such as TCP, may be used to ensure that data sent from the postal device actually is received by the storage base. Best effort protocols, such as UDP, may be used in environments where data traffic is high. Other protocols, for example, may be used to ensure secure communications and to authenticate the transmissions. For example, the postal device may encrypt the funds data, using, for example, public/private key cryptographic protocols or symmetric key protocols. In this way, the transmissions may be resistant to being revealed by unscrupulous individuals. The transmissions may be authenticated using, for example, public/private key protocols, such as digital signatures, or symmetric key protocols, such as a message authentication code (e.g., using a MAC based encryption or security system). In this way, the transmissions may be guaranteed to have been generated by the postal device.

The funds data may be received by the storage base (block 104) and be stored (block 106). The storage base may include a funds data memory for storing the funds data. The funds data memory may include volatile or non-volatile memory. Volatile memory, for example, may include random access memory or any appropriate memory which maintains the data therein so long as the memory receives power. Non-volatile memory may be preferred as the data therein does not depend on the memory receiving power. Non-volatile memory, for example, may include flash memory, hard discs, removable storage (such as rewriteable optical memory), and the like. In some example embodiments, the funds data memory may include appropriate storage for storing multiple funds data from various postal devices. For example, the funds data memory may include separate locations for storing funds data from each postal device. For example, an identifier that identifies from which postal device the particular funds data originates may be associated with each funds data. In other example embodiments, the funds data memory may be structured such that multiple instances of funds data may be stored from each postal device. Time stamps may be associated with each funds data. In this way, multiple backups of funds data may be stored for each postal device.

It is contemplated that the funds data stored at the storage base may directly correspond with the funds data derived at the postal device. However, in other example embodiments, the funds data may be stored in other forms. For example, funds data may be stored with higher precision at the storage base with, for example, five or six significant digits as opposed to two or three. In another example embodiment, the funds data may be stored on the storage base in U.S. dollars while the funds data derived on the postal device may be in a foreign currency. In a further example embodiment, the funds data on the storage base may be stored in an encrypted form.

In response to a hardware failure of the postal device, funds data may be transferred from the storage base to the postal device (blocks 108 and 110) or to a replacement postal device. A hardware failure (e.g., a memory failure) may occur in various circumstances, including power-related, physical-related, and corruption-related circumstances, etc. For example, if the information memory in the postal device is volatile memory and the postal device suffers a power loss, then the data within the information memory may be lost. In another example, the information memory may suffer a corruption, such as by a power surge or a faulty memory cell. Detection of memory errors may occur by the use of error detection memory within the postal device. In yet other example embodiments, physical damage may cause the information memory to lose the data stored therein, such as by dropping the postal device or the like.

The funds information may be restored based, at least in part, on the funds data received from the storage base (block 112). Restoration may include converting the funds data to data appropriate to be stored in the information memory. For example, as the funds data in the foregoing examples was derived from the funds information, the funds information may be calculated from the funds data in a reciprocal operation from the derivation operation. Restoring the funds data may also include storing the funds information in the information memory.

In one example embodiment, restoring the funds data may include considering any mail franked since the prior transfer of the funds data to the storage base. In some example embodiments where the funds information includes a running total of funds associated with mail already franked, the funds associated with mail franked since the funds data was transferred to the storage base may be added to the running total. In this way, the funds information may accurately represent the amount of funds franked up until the present. In some example embodiments where the funds information includes a stored value of funds remaining from which to deduct when mail is franked, the cost of funds associated with mail franked since the last time that the funds data was transferred to the storage base may be deducted from the stored value. In one example embodiment, the funds associated with mail franked since the last time that funds data was transferred to the storage base may be entered manually by a user (such as through a key pad or voice input device) or may be retrieved from a secondary memory of the postal device (such as a flash memory or removable disk).

In an aspect of the present invention, the postal authority and/or owner of the postal device may credit or debit a user account (e.g., the user/operator of the postal device) based at least in part on the amount of funds received with the funds data. A user account may have been created at the postal authority and/or with the owner/vendor of the postal device. In the case that the account includes funds from which the user deducts to frank mail, then the uncharged portion of the funds data may be credited to the user account.

For example, the funds data may include the amount of funds charged as a result of franking mail on the postal device. The funds data may include data specifying the total amount of funds that was stored on the postal device prior to the failure. Subtracting the amount of funds actually charged from the amount of funds previously stored on the postal device may result in the amount of unused funds, which may be credited to the user account. For example, $100 of funds may be initially uploaded to the postal device. Once $22 of funds has been spent, the postal device may suffer a memory or other hardware failure. The postal authority may determine that $100 was initially loaded on the postal device and subtract $22, the amount actually charged while franking mail, and credit the user account for the amount of $78.

In another example, the user account of the postal authority may store charges for mail franked. In such a scheme, the user may be billed for the running total of funds charged by the postal authority which is stored in the user account. The funds data may indicate the funds charged from franking mail on the postal device, and the postal authority may add this amount to the running total. For example, a user account may include a total of $50. The funds data may track a running total of funds charged. The amount at the time of a hardware failure may be $22. The postal authority may add the amount $22 to the amount in the user account, $50, to arrive at the new total, $72, to be billed to the user.

In yet another example embodiment, instead of adding the funds charged to a running total in the user account, the postal authority may debit the amount of funds charged on the postal device from a stored value of the user account to arrive at the amount of funds remaining in the user account once the funds charged are accounted for. For example, a user account may initially include a stored value of $100. The postal device may keep a running total of funds charged when franking mail. At the time of memory failure, $25 may be stored in the funds data. The postal authority may retrieve this amount from the storage base and deduct the amount, $100, in the user account, to arrive at the new stored value of $75.

In one example embodiment, the postal authority may verify the funds data prior to crediting or debiting the user account. Verifying the funds data may include, for example, authenticating the funds data, checking that the funds data represents valid funds information, or any appropriate operations to determine that the funds are valid. For example, verifying the funds data may include determining that the funds data was received from a valid user. In one example embodiment, a unique user identifier may be included with the funds data, and the postal authority may check the identifier against a predetermined list of user identifiers to determine whether the identifier belongs to a valid user. To prevent unscrupulous individuals from discovering the user identifier and impersonating the user, the funds data may be encrypted. In another example embodiment, a message authentication code may be included with the funds data. The postal authority and the storage base or postal device may agree on and share a secret key which may be used to encrypt cipher text. The postal authority may decrypt the cipher text and determine that the message in fact originated from a valid user.

In another example embodiment, public/private key algorithms may be used to sign and authenticate the funds data. A digital signature may be created using the private key of the storage base or postal device, depending on the design of the postage meter system. The postal authority may authenticate the digital signature by decrypting the signature block using the respective public key.

In yet other example embodiments, the funds data may be checked for validity. Validity may be determined based on surrounding data and circumstances. For example, if the user account is a debit account, the funds data may be checked to determine whether it represents funds greater than what exists in the user account. In another example, it may be determined whether the funds data represents a valid multiple of the mail being franked. For example, if each piece of mail costs 41 cents, the funds data may be verified to be a multiple of 41. The specific implementation of the verifying procedure, unless specified, is immaterial to the invention and is described for illustrative purposes.

In one example embodiment, the funds data may be transferred to the storage base after each piece of mail is franked. In this way, an accurate amount of funds may be kept at the storage base and restored on the postal device in response to a hardware failure. In other example embodiments, the transfer may occur in regular intervals, such as after every N pieces of mail are franked. In other example embodiments, the number N may vary between transfers. For example, the postal device may transfer the funds data more often when it detects that conditions are such that a hardware failure is more likely. When the postal device is in motion, there is a greater likelihood that the postal device may be dropped and suffer a hardware (e.g., a memory) failure as a result. Therefore, the funds data may be transferred to the storage base after fewer pieces of mail are franked.

In other example embodiments, the postal device may be physically and algorithmically secure from tampering, such as the postal security device disclosed in the '392 patent. In other example embodiments, the storage base may include other functionality, such as printing labels and scanning mail. In other example embodiments, the storage base may include specialized or generalized processors that permit the storage base to accomplish various tasks. In one example embodiment, the storage base may be a desktop or server computer. In yet another example embodiment, the storage base may include the postal printing base of the '392 patent.

One example embodiment may include a procedure for use with a postage meter system, including deriving funds data from a postal device after franking each one of a plurality of pieces of mail, the funds data including data from a descending register, an ascending register, and/or a piece count register in the postal device, the funds data further related to franking mail, transferring the funds data to a storage base, in response to a hardware failure of the postal device, receiving the funds data from the storage base, and restoring the funds on the postal device or a replacement [postal device based, at least in part, on the funds data received from the storage base.

One example embodiment may include a procedure for use with a postage meter system, including deriving funds data from a postal device after franking a number of a plurality of pieces of mail, the funds data including data related to franking mail, transferring the funds data to a storage base, in response to a hardware failure of the postal device, receiving the funds data from the storage base, and restoring the funds on the postal device or a replacement postal device based, at least in part, on the funds data received from the storage base and a second funds data related to mail franked since the funds data was derived. Another example embodiment may include the procedure wherein the postal device includes a postal security device. Yet another example embodiment may include the procedure wherein the storage device includes a postal printing base. A further example embodiment may include the procedure wherein the transfer step is performed periodically after franking a fixed number of mail pieces. Yet a further example embodiment may include the procedure wherein the transfer step is performed repeatedly.

One example embodiment may include the procedure wherein the funds data transferred to the storage base is stored in an encrypted form. Another example embodiment may include the procedure wherein the encryption employs symmetric key encryption. Yet another example embodiment may include the procedure wherein the encryption employs public/private key encryption. A further example embodiment may include the procedure wherein the funds data transferred to the storage base is sent over a secure communications link. Yet a further example embodiment may include the procedure further including digitally signing the funds data to be transferred to the storage base, and after receiving the funds data from the storage base, authenticating the funds data. One example embodiment may include the procedure further including digitally signing the funds data to be transferred with public/private key security techniques. Another example embodiment may include the procedure further including signing the funds data to be transferred with a message authentication code.

One example embodiment may include a procedure for use with a postage meter system, including, at a storage base, receiving, from a postal device, a funds data derived after franking a number of a plurality of pieces of mail, the funds data including data related to franking mail, storing the funds data, and in response to a hardware failure on the postal device, transferring the funds data to the postal device, wherein the funds on the postal device or replacement postal device are restored based, at least in part, on the funds data transferred to the postal device and a second funds data related to mail franked since the funds data was derived.

One example embodiment may include a procedure for use with a postage meter system, including, at a postal device, deriving funds data after franking a number of a plurality of pieces of mail, the funds data including data related to franking mail, and transferring the funds data to a storage base, at a storage base, receiving, from a postal device, a funds data, storing the funds data, and in response to a hardware failure on the postal device, transferring the funds data to the postal device, at the postal device, receiving the funds data from the storage base and restoring the funds on the postal device based, at least in part, on the funds data received from the storage base and a second funds data related to mail franked since the funds data was derived.

One example embodiment may include a system for use with a postage meter system, including an information memory configured to store information indicative of funds related to franking mail, a funds derivation component for deriving a funds data from the information, a transfer component configured to transfer the funds data to a storage base, a receive component configured to receive the funds data in response to a hardware failure of the postal device, and a restore component configured to restore the information in the information memory based, at least in part, on the funds data and a second funds data related to the mail franked since the funds data was derived.

Another example embodiment may include the system wherein the information memory includes volatile memory. Yet another example embodiment may include the system wherein the information memory includes flash memory. A further example embodiment may include the system wherein the information memory includes long term storage. Yet a further example embodiment may include the system wherein the information memory includes an ascending register. One example embodiment may include the system wherein the information memory includes a descending register.

Another example embodiment may include the system wherein the funds data is encrypted. Yet another example embodiment may include the system wherein the encrypted funds data is encrypted using symmetric key encryption techniques. A further example embodiment may include the system wherein the encrypted funds data is encrypted using public/private key encryption techniques. Yet a further example embodiment may include the system wherein the funds data is digitally signed. One example embodiment may include the system wherein the digitally signed funds data is digitally signed using public/private key security techniques. Another example embodiment may include the system wherein the funds data is signed using a message authentication code.

One example embodiment may include a system for use with a postage meter system, including a funds data receive component configured to receive a funds data derived from information in an information memory of a postal device, the information indicative of funds related to franking mail, a funds data memory configured to store the funds data, and a funds data return component configured to transfer the funds data to the postal device in response to a hardware failure of the postal device, wherein the information in the information memory is restored from the funds data.

One example embodiment may include a system for use with a postage meter system, including an information memory configured to store information indicative of funds related to franking mail, a funds derivation component for deriving a funds data from the information, a transfer component configured to transfer the funds data to a storage base, a funds data receive component configured to receive the funds data, a funds data memory configured to store the funds data, a funds data return component configured to transfer the funds data to the postal device in response to a hardware failure of the postal device, a receive component configured to receive the funds data, and a restore component configured to restore the information in the information memory based, at least in part, on the funds data and a second funds data related to the mail franked since the funds data was derived.

Information provided by indicia scanned by a postal authority can also be used to either refund, debit or credit a user's account or to restore or reset a postal device or replacement postal device. As previously discussed, the indicia of each mailpiece produced by a postal device can include funds data (e.g., one or more values of the accounting registers of the postal device at the time the indicia was generated). The indicia of each mailpiece can also include a postal device identifier, as well as customer identification or customer account information. As this indicia is scanned by the postal authority during routine processing of the mailpiece, the information of the indicia can be stored in a database and/or linked to the information of the indicia. This information can then be provided to the operator of the postal device or the vendor of the postal device to establish reliable funds data for reimbursing, crediting, or refunding a customer account. The information can also be used to restore a damaged postal device or reset/initially load a replacement postal device.

One or more indicia on a mailpiece may include the funds and postal device identification. Each of these indicia need not be scanned by the postal authority during processing. That is, one indicia can be scanned during processing and information stored in a second indicia can be correlated or matched to the scanned indicia so that all information about the mailpiece, customer and meter can be retrieved. In this way, the postal authority need not scan all indicia on a mailpiece during each stage of processing/delivery.

To recover accurate funds data in accordance with an aspect of the present invention, the most recent amount of postage or funds loaded into the postal device can be recorded. When the postal device becomes inoperable, the last indicia produced by the postal device and scanned by a postal carrier/authority can be determined. The accounting registers of the last scanned indicia can be used to establish the amount of funds remaining in the postal device at the time of failure. For example, the descending register value stored in the last scanned indicia (or associated with the last scanned indicia if, for example, the descending register value is stored in a separate indicia) can provide the remaining funds available to the postal device. This amount of funds can then be credited or debited to a user's account or can be used to load a replacement postal device.

Other means for calculating unused funds of an inoperable postal meter are also available using the information stored in mailpiece indicia. For example, the total costs of all postage printed by a postal meter can be determined (e.g., by determining the amount of postage for each mailpiece franked by a specific postal meter). This total amount of postage used by a specific postal device can be subtracted from an initial descending register value (i.e., an initial available funds amount) to determine the funds remaining in the postal device at the time of failure.

By using the funds data made available by scanning mailpiece indicia, a reliable amount of unused funds can be established. Specifically, because the data is made available by way of scanning by a postal authority, it is known that the mailpiece having the scanned indicia was processed or delivered to the postal authority for delivery. In contrast, funds data stored at the postal device can store funds data for a mailpiece that was not passed off to a postal authority for processing or delivery. Accordingly, funds data stored by the postal device locally is securely stored and verified to ensure the integrity of the derived data. Further, in some circumstances, funds data derived directly from the postal device may be adjusted by an amount of postage printed but not used in order to determine a more accurate amount of available postage (i.e., unused postage). Funds data derived from scanned indicia can also be adjusted by an amount of postage printed but not used/not passed off for delivery. For example, all indicia generated by a postal device but not scanned by a postal authority can be used to adjust a calculation of the amount of postage actually used by a postal device.

### CONCLUSION

While various embodiments of the present invention have been described above, it should be understood that they have been presented by way of example and not limitation. It will be apparent to one skilled in the pertinent art that various changes in form and detail can be made therein without departing from the spirit and scope of the invention. Therefore, the present invention should only be defined in accordance with the following claims and their equivalents.

What is claimed is:

1. A method for use with a postage meter system, comprising:
deriving secure funds data from a postal device after franking each one of a plurality of pieces of mail, the secure funds data including data from a descending register, an ascending register and a piece count register in the postal device, the secure funds data further related to franking mail;
transferring the secure funds data to a storage base;
in response to a hardware failure of the postal device, receiving the secure funds data from the storage base; and
restoring the secure funds on a replacement postal device based, at least in part, on the secure funds data received from the storage base.

2. A method for use with a postage meter system, comprising:
deriving secure funds data from a postal device after franking a number of a plurality of pieces of mail, the secure funds data including data related to franking mail and including data from a descending register, an ascending register and a piece count register of the postal device;
transferring the secure funds data to a storage base;
in response to a hardware failure of the postal device, receiving the secure funds data from the storage base; and
restoring the secure funds on a replacement postal device based, at least in part, on the secure funds data received from the storage base and a second funds data related to mail franked since the secure funds data was derived.

3. The method of claim 2, wherein the postal device includes a postal security device.

4. The method of claim 2, wherein the storage base includes a postal printing base.

5. The method of claim 2, wherein the transfer step is performed periodically after franking a fixed number of the mail pieces.

6. The method of claim 2, wherein the transfer step is performed after franking each mail piece.

7. The method of claim 2, wherein the secure funds data transferred to the storage base is stored in an encrypted form.

8. The method of claim 7, wherein the encryption employs symmetric key encryption.

9. The method of claim 7, wherein the encryption employs public/private key encryption.

10. The method of claim 2, wherein the secured funds data transferred to the storage base is sent over a secure communications link.

11. The method of claim 2, further comprising:
digitally signing the secure funds data to be transferred to the storage base; and
after receiving the secure funds data from the storage base, authenticating the secure funds data.

12. The method of claim 11, further comprising:
digitally signing the secure funds data to be transferred with public/private key security techniques.

13. The method of claim 2, further comprising:
signing the secure funds data to be transferred with a message authentication code.

14. A method for use with a postage meter system, comprising:
at a storage base, receiving, from a postal device, secure funds data derived after franking a number of a plurality of pieces of mail, the funds data including data related to franking mail and including a descending register value, an ascending register value and a piece counter register value of the postal device;
storing the secure funds data; and
in response to a hardware failure of the postal device, transferring the secure funds data to a replacement postal device,
wherein resetting funds on the replacement postal device are based, at least in part, on the secured funds data transferred to the replacement postal device.

15. A method for use with a postage meter system, comprising:
at a postal device, deriving secure funds data after franking a number of a plurality of pieces of mail, the secure funds data including data related to franking mail and including a descending register value, an ascending register value and a piece counter register value of the postal device; and
transferring the secure funds data to a storage base;
at a storage base, receiving, from a postal device, the secure funds data;
storing the secure funds data; and
in response to a hardware failure of the postal device, transferring the secure funds data to the postal device from the storage base;
at the postal device, receiving the secure funds data from the storage base; and
restoring the secure funds on a replacement postal device based, at least in part, on the secure funds data received from the storage base.

16. A method for use with a postage meter system having a stored value of funds for postage, comprising:
a user of the postage meter system entering an authorization code to activate use of the postage meter system;
executing a security algorithm to verify the entered authorization code and authorizing a printing operation of the postage meter system if the entered authorization code is valid;
performing the authorized printing operation of the postage meter system to apply an indicia to a mail item, the indicia comprising funds data comprising a descending register value of the postage meter system, an ascending register value of the postage meter system, a piece count register value of the postage meter system and an identifier of the postage meter system;
presenting the mail piece to a postal carrier for processing and delivery to a recipient;
the postal carrier scanning the mail piece to capture the indicia;
processing the indicia to determine the funds data of the indicia;
storing the funds data in a central computer server;
matching the funds data of the indicia to the postage meter system;
providing the funds data of the indicia and the identifier of the postage meter system to a service provider; and
the service provider restoring the postage funds on a replacement postage meter system when the postage meter system becomes inoperable based, at least in part, on the funds data provided by the postal carrier or refunding then postage funds to a customer account when the postage meter system becomes inoperable based, at least in part, on the funds data provided by the postal carrier.
